(19) United States
(12) Patent Application Publication
(10) Pub. No.: US 2020/0145550 A1
(43) Pub. Date: May 7, 2020

(54) PRINTING APPARATUS AND CONTROL METHOD OF THE PRINTING APPARATUS

(71) Applicant: CANON KABUSHIKI KAISHA, Tokyo (JP)

(72) Inventor: Katsuhiko Yanagawa, Toride-shi (JP)

(21) Appl. No.: 16/672,302

(22) Filed: Nov. 1, 2019

(30) Foreign Application Priority Data
Nov. 6, 2018 (JP) 2018-209093

(51) Int. Cl. H04N 1/00; H02J 3/00

(52) U.S. Cl. CPC H04N 1/00893; H04N 1/00891; H04N 1/00397; H02J 3/00

(57) ABSTRACT

A printing apparatus receives power from a commercial power supply, a power control unit can control the power supplied when the printing apparatus is powered from the commercial power supply, a storage unit can continuously store information even when power from the commercial power supply to the printing apparatus is interrupted, and based on a user operation received during such an interruption the information stored in the storage unit is switched between information indicating that an instruction to supply power is valid and information indicating that an instruction to stop power supply is valid.

### BACKGROUND

### Field

The present disclosure relates to a technique relating to start-up of a printing apparatus. Particularly, the present disclosure relates to a technique for setting whether to keep a printing apparatus which is not externally supplied with power turned off or to turn on the printing apparatus in a case where power is externally supplied thereto.

### Description of the Related Art

Printing apparatuses have a plurality of types of power source switches. One is an alternate switch such as a locker switch which maintains ON and OFF states in a hardware manner. Another one is a momentary switch such as a push switch which does not maintain ON and OFF states in a hardware manner and is turned ON only while the switch is being pressed. Therefore, a printing apparatus provided with a momentary switch includes a memory for storing ON and OFF states of a power source state of the printing apparatus. Further, the printing apparatus provided with the momentary switch stores information indicating the power source state in a nonvolatile memory and switches the information from ON to OFF or from OFF to ON every time the power source switch is operated.

Japanese Patent Application Laid-Open No. 2012-175496 discusses a technique for referring to the above-described information stored in the nonvolatile memory after a power failure is resolved and automatically returning the power source state to the one before the power failure occurs based on the information.

According to the technique discussed in Japanese Patent Application Laid-Open No. 2012-175496, the power source state before the power failure occurs is stored in the nonvolatile memory, and thus the apparatus can automatically return the power source state to the one before the power failure occurs when the power failure is resolved.

### SUMMARY

It has now been determined that in the technique discussed in Japanese Patent Application Laid-Open No. 2012-175496, a content in the nonvolatile memory cannot be rewritten during the power failure since power supply is stopped, and accordingly whether to keep the apparatus turned off or to turn on the apparatus after the power failure is resolved cannot be set during the power failure. In view of the above-discussed considerations, the present disclosure features, among other things, a technique for enabling the above-described setting during a power failure.

According to an aspect of the present disclosure, a printing apparatus includes a printing unit, a control unit configured to control the printing unit, a reception unit configured to receive user operation, a storage unit configured to store information indicating which of an instruction to supply power to the printing unit and the control unit and an instruction to stop power supply to the printing unit and the control unit is valid, a change unit configured to change the information stored in the storage unit, and a power control unit configured to control power supply to the printing unit and the control unit based on the information stored in the storage unit, wherein the printing apparatus receives power supply from a commercial power supply, wherein the power control unit performs the control of power supply in a state in which the printing apparatus is supplied with power from the commercial power supply, wherein the storage unit continuously stores the information in a state in which power supply from the commercial power supply to the printing apparatus is interrupted, and wherein, based on a user operation with respect to the reception unit received in a state in which power supply from the commercial power supply to the printing apparatus is interrupted, the change unit switches the information stored in the storage unit between information indicating that the instruction to supply power is valid and information indicating that the instruction to stop power supply is valid.

Further features of the present disclosure will become apparent from the following description of exemplary embodiments with reference to the attached drawings.

### BRIEF DESCRIPTION OF THE DRAWINGS

FIG. 1 is a diagrammatic illustration of a printing apparatus according to a first exemplary embodiment.

FIG. 2 is a block diagram illustrating an internal configuration of a main controller unit according to the first exemplary embodiment.

FIG. 3 is a block diagram illustrating control by a power source control unit according to the first exemplary embodiment.

FIG. 4 is a block diagram illustrating an internal configuration of a power source switching unit according to the first exemplary embodiment.

FIG. 5 is a block diagram illustrating internal configurations of a state storage unit and a power source switch unit according to the first exemplary embodiment.

FIG. 6 is a truth table indicating operations of a flip-flop according to the first exemplary embodiment.

FIG. 7 is a flowchart illustrating operations of the power source control unit according to the first exemplary embodiment.

FIG. 8 is a flowchart illustrating operations of a central processing unit (CPU) according to the first exemplary embodiment.

FIG. 9 is a block diagram illustrating an internal configuration of a state storage unit according to a second exemplary embodiment.

FIG. 10 is a flowchart illustrating operations of a power source control unit according to the second exemplary embodiment.

FIG. 11 is a block diagram illustrating an internal configuration of a main controller unit according to a third exemplary embodiment.

FIG. 12 is a block diagram illustrating internal configurations of a state storage unit and a power source switch unit according to the third exemplary embodiment.

FIG. 13 is a flowchart illustrating operations of a power source control unit according to the third exemplary embodiment.

### DESCRIPTION OF THE EMBODIMENTS

Various exemplary embodiments of the present disclosure will be described in detail below with reference to the attached drawings.

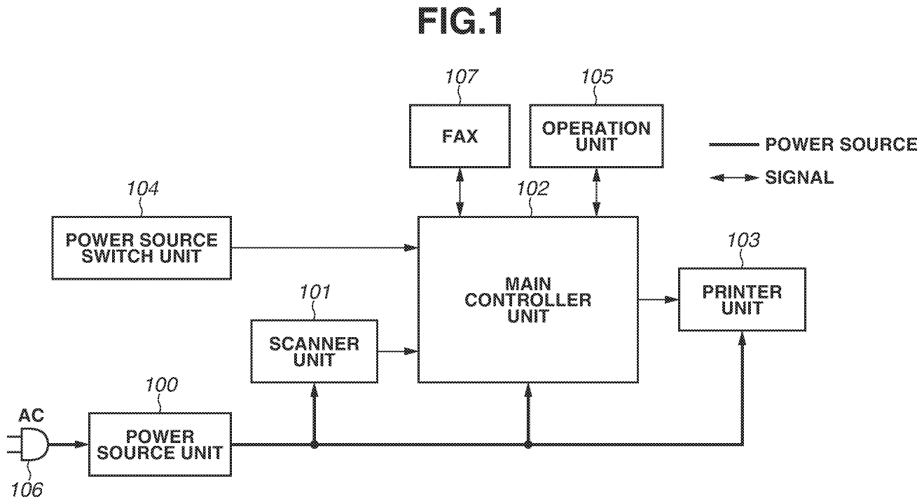

FIG. 1 is a diagrammatic illustration of a printing apparatus according to a first exemplary embodiment of the present disclosure. The printing apparatus includes a power source unit 100, a scanner unit 101, a main controller unit (a control unit) 102, a printer unit (a printing unit) 103, a power source switch unit (a reception unit) 104, an operation unit 105, an alternate current (AC) plug 106, and a facsimile (FAX) 107.

In FIG. 1, the scanner unit 101 optically reads an image from a document and converts the read image into a digital image. The printer unit 103 performs image forming processing on a sheet-like recording medium (a sheet) according to, for example, an electrophotographic method. The recording method is not limited to the electrophotographic method as long as the printer unit 103 can perform image processing on both sides of a sheet-like recording medium (for example, recording paper), and another recording method such as an ink-jet method and a thermal transfer method may be used.

The main controller unit 102 entirely controls the printing apparatus and performs, for example, copy operation control for causing the scanner unit 101 to read a document image and causing the printer unit 103 to print the read document image.

The AC plug 106 is inserted into an electric outlet outside of the printing apparatus, and thus the power source unit 100 is supplied with an AC commercial power supply (for example, 100 V). The power source unit 100 includes an alternating current to direct current (AC-DC) converter which converts the voltage of the commercial power supply into a desired DC voltage (for example, 12 V) and is configured to supply the DC voltage converted by the AC-DC converter to the main controller unit 102, or alternatively a part thereof, in a case where the commercial power supply is supplied. Accordingly, if supply of the commercial power supply to the power source unit 100 is stopped by a power failure and the like, supply of the DC voltage is also stopped.

The power source switch unit 104 is configured by a momentary push switch and the like which does not maintain ON and OFF states in a hardware manner and notifies the main controller unit 102 of pressing of the power source switch unit 104 by a user. The power source switch unit 104 is a reception unit which receives an ON instruction to supply power to each of units in the printing apparatus such as the main controller unit 102, the printer unit 103, the operation unit 105, and the FAX 107 and an OFF instruction to stop power supply to each of the units from a user.

The operation unit 105 connected to the main controller unit 102, includes a liquid crystal panel for operation and hard keys including a power saving mode release button, and receives an instruction input by a user. The FAX 107 transmits and receives image data to and from a facsimile device in a remote location via a public line.

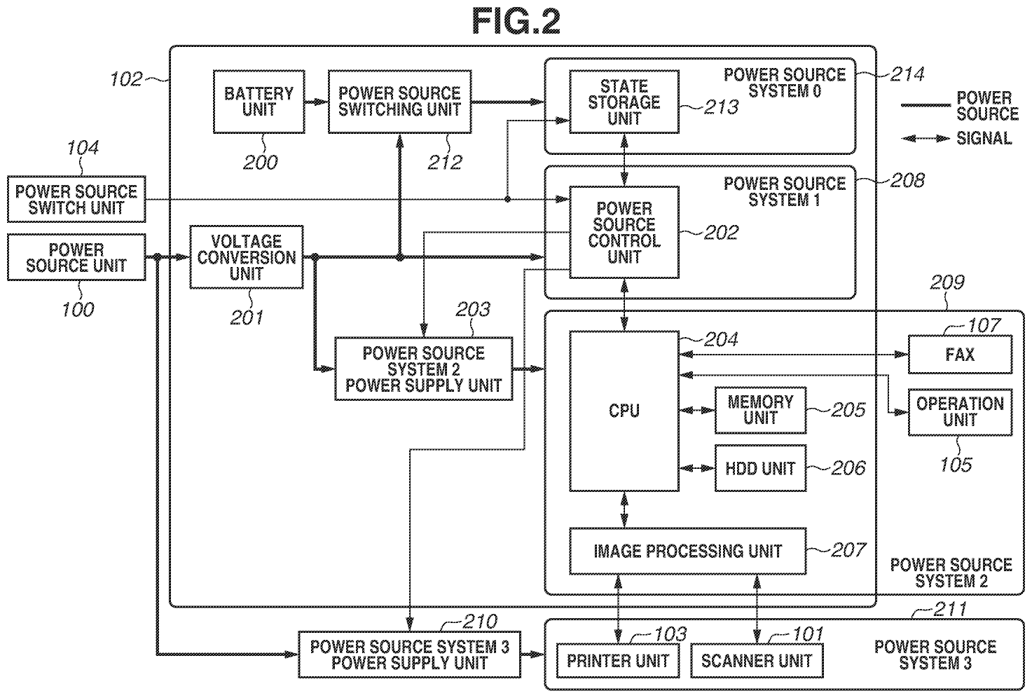

FIG. 2 is a block diagram illustrating an internal configuration of the main controller unit 102 according to the first exemplary embodiment of the present disclosure. The main controller unit 102 includes a battery unit 200, a voltage conversion unit 201, a power source control unit (a power control unit) 202, a power source system 2 power supply unit 203, a central processing unit (CPU) 204, a memory unit 205, a hard disk drive (HDD) unit 206, an image processing unit 207, a power source switching unit 212, and a state storage unit 213.

The battery unit 200 is a primary battery or a rechargeable/dischargeable secondary battery. According to the first exemplary embodiment, it is described that the output voltage of the battery unit 200 is a DC +3 V, but the output voltage is not limited to this.

The voltage conversion unit 201 converts a power source voltage (for example, DC 12 V) supplied from the power source unit 100 into a voltage used by each control unit and supplies the voltage to each control unit. According to the first exemplary embodiment, it is described that the output voltage of the voltage conversion unit 201 is a DC +3.3 V, but the output voltage is not limited to this. However, a diode is used in the power source switching unit 212 according to the present exemplary embodiment, as described below in such a manner that it is necessary to make the output voltage of the voltage conversion unit 201 larger than the output voltage from the battery unit 200.

The power source switching unit 212 switches a power source (DC 3 V) from the battery unit 200 and a power source (DC 3.3 V) from the voltage conversion unit 201 and supplies the power source to a power source system 0 including the state storage unit 213. The state storage unit 213 includes a flip-flop as described below and corresponds to a volatile storage unit. Accordingly, in order to continuously store information in the state storage unit 213 in this embodiment, it is necessary to continuously supply power to the state storage unit 213. The state storage unit 213 stores information indicating which of the ON instruction to supply power to each of the units in the printing apparatus and the OFF instruction to stop power supply to each of the units is valid as described below. The information indicating that the ON instruction to supply power to each of the units in the printing apparatus is valid is referred to as an ON setting, and the information indicating that the OFF instruction to stop power supply to each of the units is valid is referred to as an OFF setting. In other words, the state storage unit 213 stores the ON setting or the OFF setting.

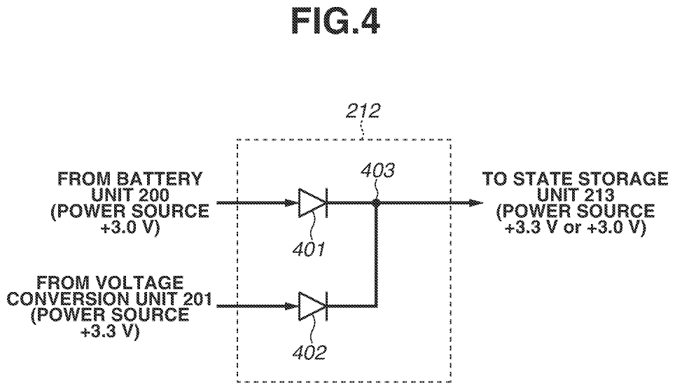

A configuration example of the power source switching unit 212 is illustrated in FIG. 4. In FIG. 4, outputs of diodes 401 and 402 are connected to a contact 403. An output voltage from any of the diodes 401 and 402 is supplied via the contact 403 to the power source system 0 including the state storage unit 213. A diode has a characteristic of readily carrying a current in a case of being applied with a forward bias and hardly carrying a current in a case of being applied with a reverse bias. Accordingly, in a case where the output voltage of the battery unit 200 is +3 V, and the output voltage of the voltage conversion unit 201 is +3.3 V, only the diode 402 on a side of the voltage conversion unit 201 having a higher voltage carries a current. In other words, in a case where power is supplied to the printing apparatus itself from an external commercial power supply, the output voltage (3.3 V) from the voltage conversion unit 201 is supplied to the state storage unit 213. On the other hand, in a case where the AC plug 106 is not connected to the commercial power supply or in a case of a power failure, in other words, in a case where power is not externally supplied to the printing apparatus itself, the output voltage of the voltage conversion unit 201 is 0 V. Accordingly, only the diode 401 on a side of the battery unit 200 carries a current, and the output voltage (3 V) from the battery unit 200 is supplied to the state storage unit 213.

The power source control unit 202 is an integrated circuit and connected to the power source switch unit 104, the power source system 2 power supply unit 203, a power source system 3 power supply unit 210, the CPU 204, and the state storage unit 213. The power source control unit 202 performs switching control on the power source system 2 power supply unit 203 and the power source system 3 power supply unit 210 so as to supply and interrupt the power source to each of the units in the printing apparatus according to an operation on the power source switch unit 104 and a control program executed by the CPU 204. The power source system 2 power supply unit 203 and the power source system 3 power supply unit 210 are field-effect transistors (FETs) or the like and supply and interrupt the output voltages from the voltage conversion unit 201 and the power source unit 100 to a power source system 2 and a power source system 3 based on a signal from the power source control unit 202. The power source control unit 202 performs a setting of a start-up state of the printing apparatus with respect to the state storage unit 213. The power source control unit 202 controls the power source system 2 power supply unit 203 and the power source system 3 power supply unit 210 based on the setting of the state storage unit 213 (namely the ON setting or the OFF setting). As described above, the power source control unit 202 controls power supply to each of the units in the printing apparatus such as the main controller unit 102, the printer unit 103, the operation unit 105, and the FAX 107 based on the setting (the information) stored in the state storage unit 213 at present.

The CPU 204 is a central processing unit which entirely controls the printing apparatus and realizes a copy function, a print function, a FAX function, and the like based on a control program stored in the HDD unit 206. The memory unit 205 is connected to the CPU 204. The memory unit 205 is a volatile memory such as a double data rate synchronous dynamic random access memory (DDR SDRAM) and is a main memory which stores user data generated by a control program executed by the CPU 204 and the like. The HDD unit 206 is connected to the CPU 204. The HDD unit 206 is a storage device for storing a program to be executed by the CPU 204 and various pieces of setting information regarding the printing apparatus. The image processing unit 207 is connected to the CPU 204, the printer unit 103, and the scanner unit 101. The image processing unit 207 performs image processing such as color space conversion on a digital image output from the scanner unit 101 and outputs data after subjected to the image processing to the CPU 204. The image processing unit 207 further performs image processing such as color space conversion based on image data read by the scanner unit 101 to convert the image data into bitmap data and outputs the bitmap data to the printer unit 103.

Next, the power source systems in the printing apparatus are described with reference to FIG. 2.

The power source system 0 to the power source system 3 are described below, but the number of the power source systems is not limited to this. In a case where a power source derived from the power source unit 100 is not supplied because of a power failure or the like, a power source derived from the battery unit 200 which is different from the power source unit 100 is supplied to the power source system 0. On the other hand, in a case where the power source derived from the power source unit 100 is not supplied, the power source is not supplied to a power source system 1, the power source system 2, and the power source system 3.

The power source system 0 214 supplies a power source to the state storage unit 213 at the output voltage from the power source switching unit 212. The power source switching unit 212 selects and outputs a higher one of the output voltage of the battery unit 200 and the output voltage of the voltage conversion unit 201, so that the power source system 0 214 is supplied with the power source from the battery unit 200 even in a case where the output of the voltage conversion unit 201 is turned off by a power failure or the like. As described above, the power source is supplied from the battery unit 200 if a power failure or the like occurs, and thus the setting of the state storage unit 213 can be changed from the ON setting to the OFF setting by a user operation with respect to the power source switch unit 104 during the power failure as described below. In other words, the printing apparatus according to the present exemplary embodiment can receive a user operation for changing the setting information stored in the state storage unit 213 from the one setting information to the other setting information in a state in which a power supply from the commercial power supply to the printing apparatus is interrupted. Further, the printing apparatus includes a change unit which can change the setting information stored in the state storage unit 213 from the one setting information to the other setting information based on the received user operation in a state in which the power supply from the commercial power supply is interrupted.

The power source system 1 208 supplies the power source to the power source control unit 202. The power source system 1 208 is supplied with the power source as long as the commercial power supply is supplied from the AC plug 106. As long as the power source system 1 208 is supplied with the power source, the power source control unit 202 can control power to each of the units in the printing apparatus.

The power source system 2 209 supplies the power source to the CPU 204, the memory unit 205, the HDD unit 206, the image processing unit 207, the operation unit 105, and the FAX 107. As long as the power source system 2 209 is supplied with the power source, the above-described modules can be used. Control of interruption/supply of the power source to the power source system 2 209 is realized by controlling the power source system 2 power supply unit 203 based on a control signal output from the power source control unit 202. In this regard, the power source supply to the power source system 2 209 is stopped in a power saving mode which is a state for reducing power consumption of an entire printing apparatus and in a case where the power state of the printing apparatus is a power-off state.

A power source system 3 211 supplies the power source to the scanner unit 101 and the printer unit 103. As long as the power source system 3 211 is supplied with the power source, the above-described modules can be used. Control of interruption/supply of the power source to the power source system 3 211 is realized by controlling the power source system 3 power supply unit 210 based on a control signal output from the power source control unit 202. In this regard, the power source supply to the power source system 3 211 is stopped in the power saving mode which is the state for reducing power consumption of the entire printing apparatus and in a case where the power state of the printing apparatus is the power-off state.

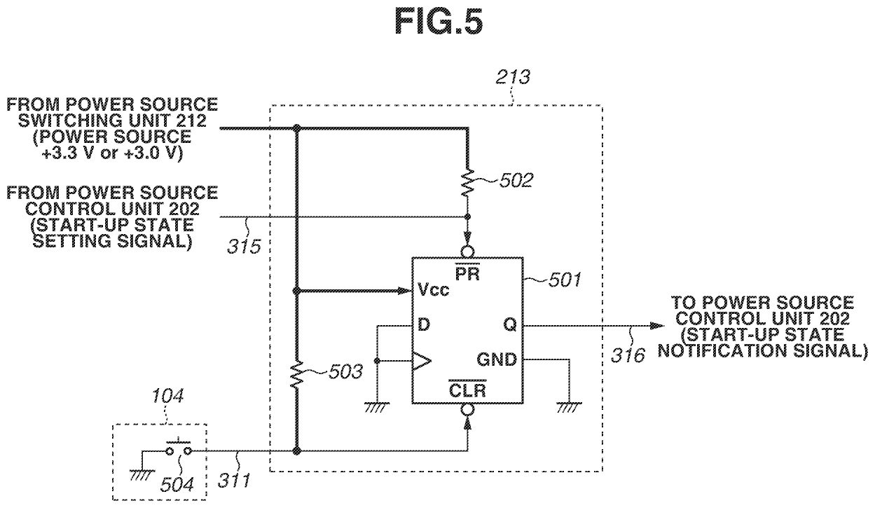

FIG. 5 is a block diagram illustrating the state storage unit 213 and the power source switch unit 104 in details. In FIG. 5, a flip-flop 501, resistors 502 and 503, and a push switch 504 are illustrated. The state storage unit 213 outputs a start-up state notification signal 316. The start-up state notification signal 316 in a low level indicates that shut-down processing is normally performed, and the printing apparatus is normally completed. The start-up state notification signal 316 in a high level indicates that the shut-down processing is not normally performed due to a factor of, for example, a power failure, and the printing apparatus is abnormally completed. A signal in a high level represents a signal having a first predetermined voltage value or higher, and a signal in a low level represents a signal having a second predetermined voltage value which is lower than the first predetermined voltage value or lower. A fact that a signal is in the high level refers to that the signal is high, and a fact that a signal is in the low level refers to that the signal is low.

The start-up state notification signal 316 is used to determine whether to turn the printing apparatus to the power-off state in a case where the commercial power supply is changed from a state not being supplied to the power source unit 100 to a state being supplied thereto. For example, in a case where the start-up state notification signal 316 is low when the commercial power supply is supplied to the power source unit 100, the printing apparatus is turned to the power-off state. In other words, the printing apparatus is brought into the power-off state in which power is supplied to the power source systems 0 and 1 and is not supplied to the power source systems 2 and 3. On the other hand, in a case where the start-up state notification signal 316 is high when the commercial power supply is supplied to the power source unit 100, the printing apparatus is turned to, for example, a normal power state. In other words, the printing apparatus is brought into the normal power state in which power is supplied to the power source systems 0, 1, 2, and 3.

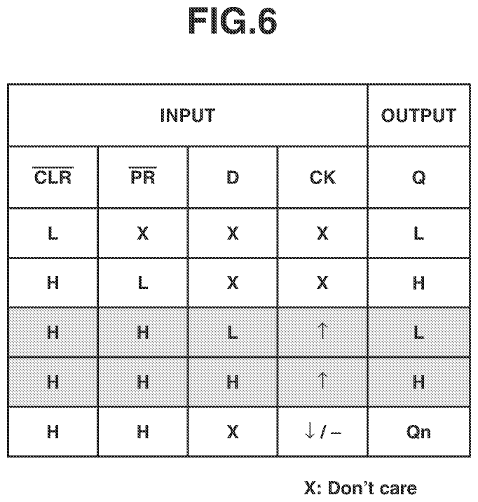

A truth table of the flip-flop 501 is illustrated in FIG. 6. As indicated in the truth table in FIG. 6, in a case where an input to a clear (CLR) terminal is low, an output from a Q terminal is cleared and to be low regardless of levels of inputs to other terminals. In a case where an input to the CLR terminal is high, and an input to a preset (PR) terminal is low, the output from the Q terminal is set to high. Further, an input to a D terminal and an input to a clock (CLK) terminal are short-circuited (grounded) to a ground (GND), so that if the input to the CLR terminal and the input to the PR terminal are high, a level of the output from the Q terminal is maintained. The resistor 502 is connected between a start-up state setting signal 315 and the power source (a signal from the power source switching unit 212) and keeps a signal level of the start-up state setting signal 315 high in a case where the power source control unit 202 is turned off by a power failure or the like, and the start-up state setting signal 315 is not driven.

One terminal of the push switch 504 is grounded to the GND. In a case where the push switch 504 is pressed during when power is supplied to the state storage unit 213, a power source switch state signal 311 becomes low. In addition, the power source switch state signal 311 is connected to the power source via the resistor 503, and thus, in a case where the push switch 504 is not pressed during when the power is supplied to the state storage unit 213, the power source switch state signal 311 becomes high. In other words, in a period in which the power is supplied to the state storage unit 213, if the push switch 504 is pressed, an input level to the CLR terminal becomes low, and if the push switch 504 is not pressed, the input level to the CLR terminal becomes high.

Accordingly, if the power source switch unit 104 is pressed, the power source switch state signal 311 becomes low, and the output from the Q terminal of the internal flip-flop 501 is cleared in the state storage unit 213, so that the start-up state notification signal 316 becomes low. If the start-up state setting signal 315 is turned into low by the power source control unit 202 in a state in which the input to the CLR terminal is high, the output from the Q terminal of the flip-flop 501 is set to high. In other words, if the power source control unit 202 sets the start-up state setting signal 315 to low in a state in which the power source switch unit 104 is not pressed, an input to the PR terminal is set to low, and the output from the Q terminal of the flip-flop high is set to high. Accordingly, the start-up state notification signal 316 becomes high.

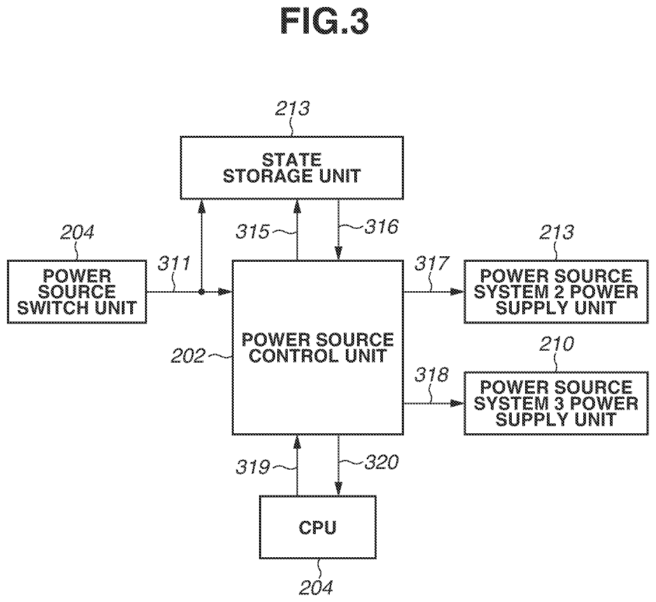

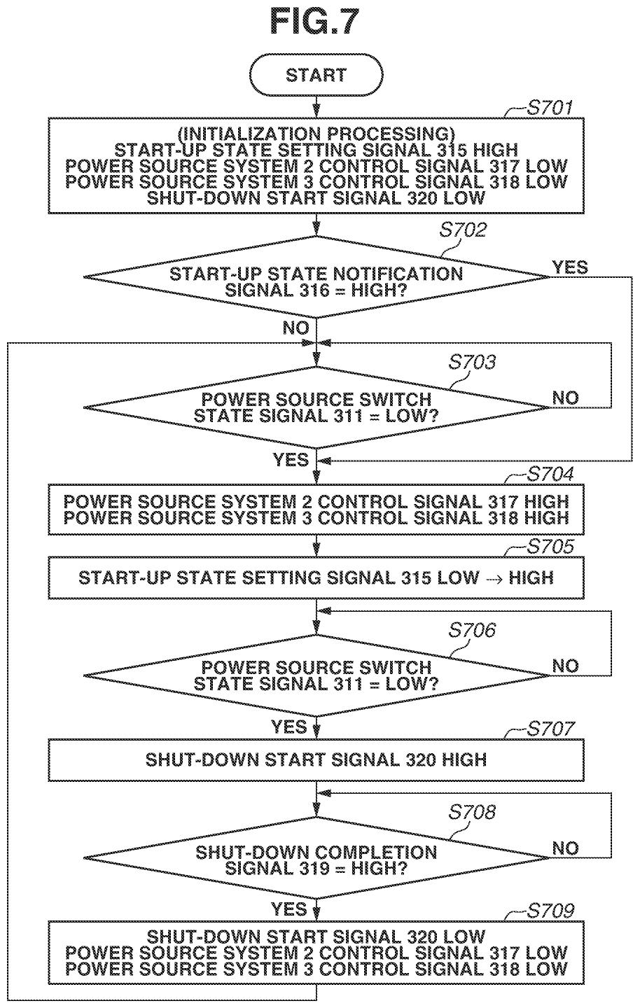

FIG. 7 is a flowchart illustrating operations of the power source control unit 202 according to the present exemplary embodiment. FIG. 3 is a block diagram illustrating the power source control unit 202 and various signals connected thereto in detail. The operations of the power source control unit 202 are described in detail below with reference to FIGS. 3 and 7.

In step S701, in a case where the output voltage of +3.3 V is supplied from the voltage conversion unit 201, the power source control unit 202 sets the start-up state setting signal 315 to high and sets a power source system 2 control signal 317, a power source system 3 control signal 318, and a shut-down start signal 320 to low. In this regard, the push switch 504 of the power source switch unit 104 is not pressed at a timing when the output voltage is supplied from the voltage conversion unit 201 to the power source control unit 202. The start-up state setting signal 315 is connected to the PR terminal of the flip-flop 501 in the state storage unit 213, and a signal level thereof is high.

Before the output voltage is supplied from the voltage conversion unit 201, in other words, the printing apparatus is in a state in which power is not externally supplied thereto, the above-described battery unit 200 supplies predetermined power of +3.0 V to the state storage unit 213. In other words, if the commercial power supply is not supplied to the power source unit 100, and the start-up state setting signal 315 cannot be kept at high, the input to the PR terminal can be kept at high by the power source switching unit 212. Accordingly, if the push switch 504 is not pressed, the output from the Q terminal (the start-up state notification signal 316) does not change before and after power is supplied from outside of the printing apparatus. Thus, if the push switch 504 of the power source switch unit 104 is not operated during a power failure, the output from the Q terminal (the start-up state notification signal 316) does not change before and during the power failure and after the power failure is resolved, and the external power is started to be supplied. As described above, the state storage unit 213 stores information which is changed in response to an operation on the push switch 504. Further, as described below, power supply to each of the units in the printing apparatus (particularly the power source system 2 and the power source system 3) is controlled by the power source control unit 202 based on the information stored in the state storage unit 213 at present.

The power source system 2 control signal 317 is connected to the power source system 2 power supply unit 203 but is low, so that the power source system 2 209 is kept at OFF. Similarly, the power source system 3 control signal 318 is connected to the power source system 3 power supply unit 210 but is low, so that the power source system 3 211 is kept at OFF.

Next, in step S702, the power source control unit 202 checks whether the state of the start-up state notification signal 316 from the state storage unit 213 is high. In a case where the state is high (YES in step S702), the processing proceeds to step S704, and in a case where the state is not high (NO in step S702), the processing proceeds to step S703.

In a case where the state of the start-up state notification signal 316 is low (NO in step S702), it can be determined that the shut-down processing is normally completed or a user operates the power source switch unit 104 during a power failure. Accordingly, the power source control unit 202 does not automatically start the printing apparatus and waits for a user to operate the power source switch unit 104. In other words, in step S703, the power source control unit 202 checks whether the state of the power source switch state signal 311 is low, and the processing remains in step S703 until the state becomes low. Then, the power source control unit 202 performs processing in step S704 and the subsequent steps by detecting that the power source switch state signal 311 becomes low. In other words, the power source control unit 202 detects that the push switch 504 of the power source switch unit 104 becomes a pressed state and then becomes an unpressed state and performs the subsequent processing. In a state in which the push switch 504 is not pressed, the input to the CLR terminal is high.

Next, the power source control unit 202 performs following processing. Specifically, in step S704, the power source control unit 202 sets the power source system 2 control signal 317 and the power source system 3 control signal 318 to high. The power source system 2 control signal 317 and the power source system 3 control signal 318 become high, so that the power source supply to the power source system 2 209 and the power source system 3 211 is started, and the power source system 2 209 and the power source system 3 211 are shifted to a power-on state.

In step S702, in a case where the state of the start-up state notification signal 316 is high (YES in step S702), it can be determined that abnormal completion occurs due to a power failure or the like, and then a user does not operate the power source switch unit 104, so that the processing proceeds to step S704. In step S704, the power source control unit 202 sets the power source system 2 control signal 317 and the power source system 3 control signal 318 to high, thus starts the power source supply to the power source system 2 209 and the power source system 3 211, and shifts them to the power-on state.

Next, in step S705, the power source control unit 202 sets the start-up state setting signal 315 which is high to low once and then sets it to high again. The push switch 504 is not in the pressed state at a timing when the processing in step S705 is performed, so that the input to the CLR terminal is high. Accordingly, the start-up state notification signal 316 which is the output from the Q terminal of the flip-flop high in the state storage unit 213 is set to high, and this state is maintained while the power source unit 100 is supplied with the commercial power supply. In other words, the power source control unit 202 sets information indicating that the printing apparatus is being started to the state storage unit 213. Further, in a case where the information (the information indicating that the printing apparatus is being started) is referred to in step S702 in a next time, the processing in step S704 is executed by skipping the processing in step S703, so that if a power failure occurs during start-up of the printing apparatus, and then the power failure is solved, the printing apparatus is automatically started up.

Next, in step S706, the power source control unit 202 checks whether the state of the power source switch state signal 311 is low, and the processing remains in step S706 until the state becomes low. In a case where a user presses the push switch 504 of the power source switch unit 104, and the state of the power source switch state signal 311 becomes low (YES in step S706), in step S707, the power source control unit 202 drives the shut-down start signal 320 to high. The shut-down start signal 320 is connected to the CPU 204, and if the shut-down start signal 320 becomes high, the CPU 204 starts the shut-down processing. In a case where the shut-down processing is completed, the CPU 204 outputs a shut-down completion signal 319 to the power source control unit 202. If the state of the power source switch state signal 311 becomes low, the input level to the CLR terminal of the flip-flop 501 also becomes low. Accordingly, the output from the Q terminal of the internal flip-flop 501 in the state storage unit 213 is cleared, and the start-up state notification signal 316 becomes low.

Next, in step S708, the power source control unit 202 checks whether the shut-down completion signal 319 is high, and the processing remains in step S708 until the CPU 204 completes the shut-down processing, and the shut-down completion signal 319 becomes high. In a case where the shut-down completion signal 319 becomes high (YES in step S708), in step S709, the power source control unit 202 sets the shut-down start signal 320, the power source system 2 control signal 317, and the power source system 3 control signal 318 to low and returns the processing to step S703. Since both of the power source system 2 control signal 317 and the power source system 3 control signal 318 become low, the power source control unit 202 stops the power source supply to the power source system 2 209 and the power source system 3 211 and shifts them to the power-off state. As described in steps S704 and S709, the power source control unit 202 can control power supply and interruption of the power supply to each of the units in the printing apparatus in a state in which the power source unit 100 is supplied with the commercial power supply.

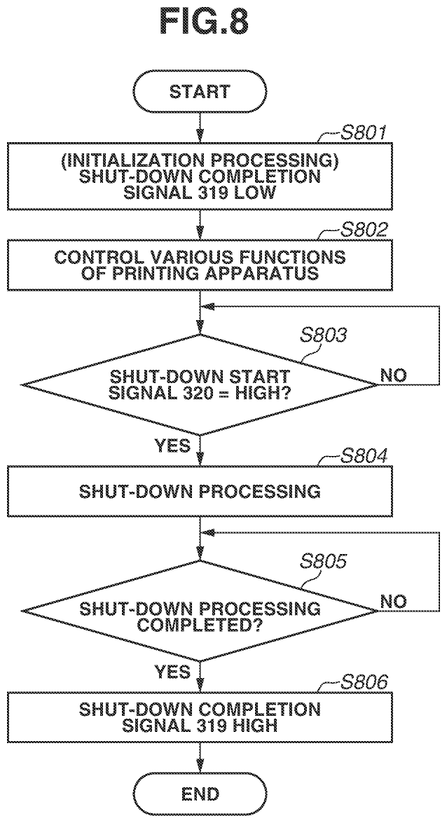

FIG. 8 is a flowchart illustrating operations of the CPU 204 according to the first exemplary embodiment of the present disclosure.

First, in step S801, in a case where the power source is turned on, the CPU 204 performs initialization processing and sets the shut-down completion signal 319 to low. The high level and the low level of the shut-down completion signal 319 respectively mean completion and non-completion of the shut-down processing.

Next, in step S802, the CPU 204 executes control of various functions of the printing apparatus. The control of various functions includes print function control, scan function control, and FAX function control. For example, in a case where a FAX reservation transmission function is set which is a function of automatically transmitting a FAX at a reservation time set in advance, the function can be achieved by the printing apparatus automatically starting up after recovery from a power failure. On the other hand, some users want to turn off the printing apparatus from a view point of energy saving during night-time and the like when users are absent. However, a conventional printing apparatus has an issue that the printing apparatus is certainly started up after recovery from a power failure, and thus the printing apparatus cannot be turned off without waiting recovery from the power failure.

Next, in step S803, the CPU 204 checks whether the shut-down start signal 320 is high. In a case where the CPU 204 detects that the shut-down start signal 320 is high (YES in step S803), in step S804, the CPU 204 performs the shut-down processing according to a shut-down program.

Next, in step S805, the CPU 204 waits for completion of the shut-down processing. In a case where the shut-down processing is completed (YES in step S805), the CPU 204 drives the shut-down completion signal 319 to high and terminates the processing.

As described above, the start-up state notification signal 316 which is the output from the Q terminal of the flip-flop 501 in the state storage unit 213 can be cleared by a user operation on the power source switch unit 104 even during a power failure. Accordingly, automatic start-up at the time of recovery from a power failure can be canceled, and the printing apparatus can be kept in the OFF state.

According to the first exemplary embodiment, the method for turning off the printing apparatus during a power failure is described. According to a second exemplary embodiment, in contrast, a method for automatically starting up a printing apparatus which is not automatically started up after recovery from a power failure in a normal case, after recovery from the power failure by a user operation on a power source switch unit during the power failure is described.

Differences from the first exemplary embodiment are only an internal configuration of a state storage unit 213 and an operation of a power source control unit 202.

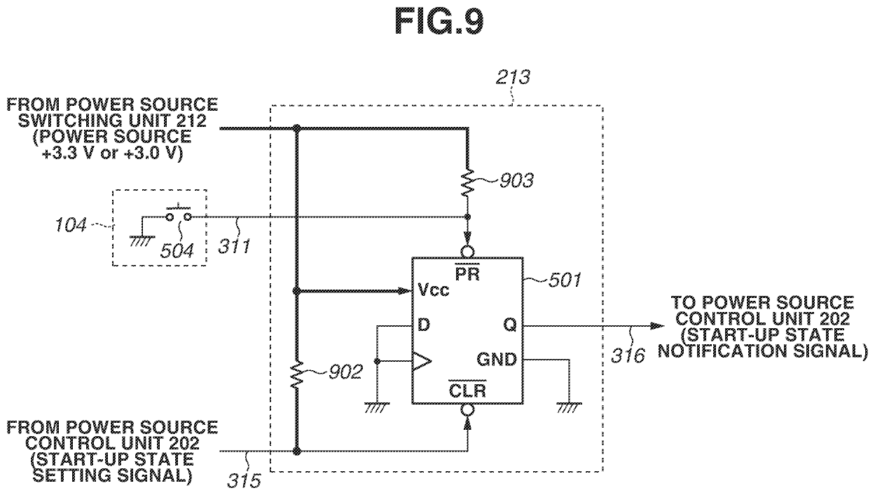

FIG. 9 is a block diagram illustrating details of an internal configuration of the state storage unit 213 according to the second exemplary embodiment. In FIG. 9, same reference numbers are assigned to components same as those according to the first exemplary embodiment.

The state storage unit 213 includes a flip-flop 501 and resistors 902 and 903. A low level and a high level of a start-up state notification signal 316 as an output signal of the state storage unit 213 respectively indicates that automatic start-up is off and on.

A start-up state setting signal 315 is connected to a CLR terminal of the flip-flop 501 and to a power source via the resistor 902 and is kept at a high signal level in a case where the power source control unit 202 is turned off by a power failure or the like, and the start-up state setting signal 315 cannot be driven.

A power source switch state signal 311 is connected to a PR terminal of the flip-flop 501 and to the power source via the resistor 903 and is kept at a high signal level in a case where a push switch 504 is not pressed.

Accordingly, if a power source switch unit 104 is pressed, the power source switch state signal 311 is set to low and an output from a Q terminal of the internal flip-flop 501 is set to high in the state storage unit 213. In other words, the start-up state notification signal 316 becomes high which indicates that the automatic start-up is on. In a case where the start-up state setting signal 315 is driven by the power source control unit 202 at low, the output from the Q terminal of the internal flip-flop 501 is cleared, and the start-up state notification signal 316 becomes low which indicates that the automatic start-up is off.

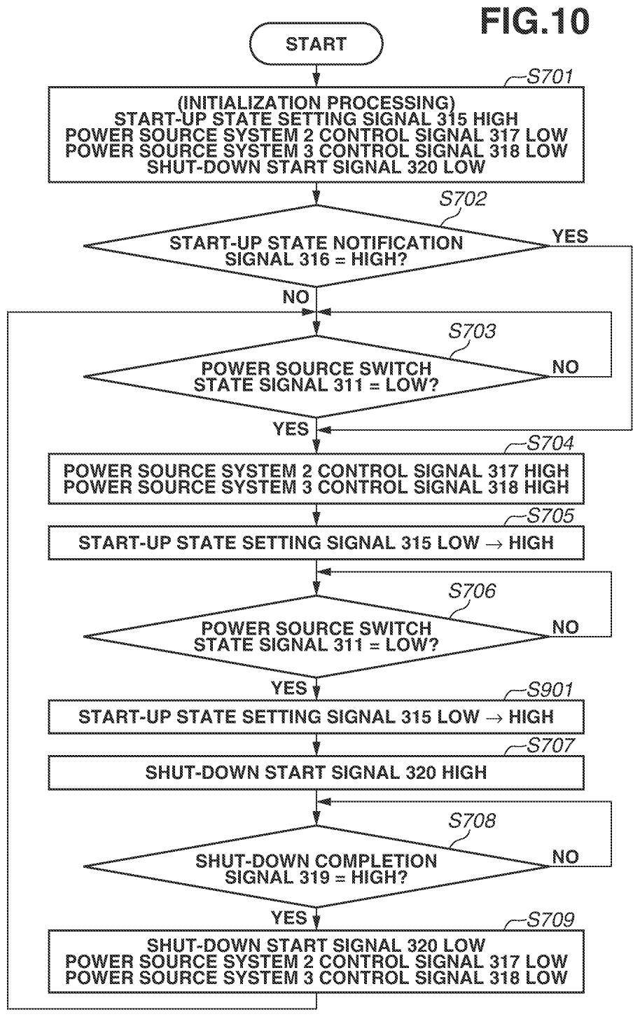

FIG. 10 is a flowchart illustrating operations of the power source control unit 202 according to the second exemplary embodiment of the present disclosure, and the operations of the power source control unit 202 are described with reference to FIG. 10.

In FIG. 10, same numbers are assigned to steps same as those according to the first exemplary embodiment.

First, steps S701 to S706 are the same as those according to the first exemplary embodiment.

Next, in a case where the power source control unit 202 detects that a user presses the push switch 504 of the power source switch unit 104, and the state of the power source switch state signal 311 becomes low (YES in step S706), the power source control unit 202 sets the start-up state setting signal 315 to low. Subsequently, in step S901, the power source control unit 202 sets the start-up state setting signal 315 to high and thus clears the start-up state notification signal 316 as the output from the Q terminal of the flip-flop 501 in the state storage unit 213 to low. This is because, if a user presses the push switch 504 of the power source switch unit 104, and the state of the power source switch state signal 311 becomes low, the output from the Q terminal of the flip-flop 501 is set to high.

Next, the processing proceeds to step S707. However, the subsequent steps are same as those according to the first exemplary embodiment, so that the descriptions thereof are omitted.

As described above, the output from the Q terminal of the flip-flop 501 in the state storage unit 213 which is operated by the power source of the battery unit 200 can be changed by pressing of the push switch 504 by a user during a power failure state. Accordingly, the output level of the start-up state notification signal 316 is changed, and the printing apparatus can be automatically started up at the time of recovery from a power failure.

According to the first exemplary embodiment, the flip-flop 501 is kept in a state during a power failure using power from the battery unit 200. According to a third exemplary embodiment, a printing apparatus eliminates a need for a battery unit 200 using a capacitor and a diode without using a flip-flop 501, and a method thereof is described. An idea in common with the first exemplary embodiment is that the printing apparatus includes a unit which can set whether to automatically start up the printing apparatus in a case where a power source unit 100 is supplied with power if there is no power supply from the power source unit 100 (a voltage conversion unit 201).

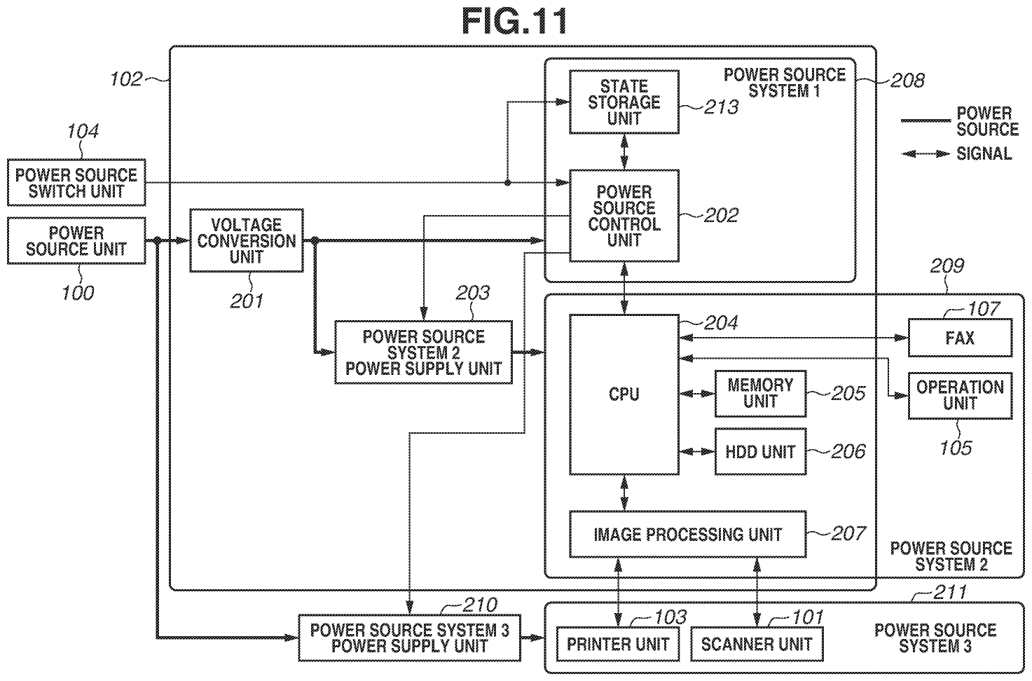

FIG. 11 is a block diagram illustrating an internal configuration of a main controller unit 102 according to the third exemplary embodiment, and only a difference from the first exemplary embodiment is described. According to the third exemplary embodiment, the main controller unit 102 does not include the battery unit 200, a power source switching unit 212, and a power source system 0, and a state storage unit 213 included in the power source system 0 is included in a power source system 1. An internal configuration of a state storage unit 213 is changed which is described in detail below. Other parts are similar to those according to the first exemplary embodiment, and thus the descriptions thereof are omitted.

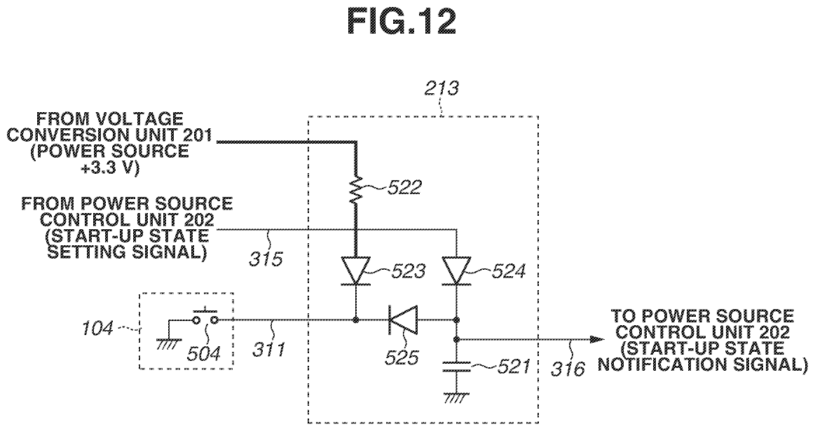

FIG. 12 is a block diagram illustrating details of internal configurations of the state storage unit 213 and a power source switch unit 104. In FIG. 12, the state storage unit 213 includes a capacitor 521, a resistor 522, and diodes 523, 524, and 525. A start-up state notification signal 316 is an output signal of the state storage unit 213.

If a start-up state setting signal 315 from a power source control unit 202 becomes high, the diode 524 is conducted, the capacitor 521 is charged with electric charges, and the start-up state notification signal 316 becomes high. On the other hand, if a push switch 504 is pressed, a power source switch state signal 311 becomes low by being short-circuited to the GND, so that the diode 525 is conducted, and the electric charges held by the capacitor 521 are discharged. Accordingly, the start-up state notification signal 316 becomes low.

The power source switch state signal 311 is connected to a power source via the diode 523 and the resistor 522, so that the power source switch state signal 311 is high in a case where the push switch 504 is not pressed. The diode 524 is provided so that the electric charges held by the capacitor 521 are not discharged when the power source is turned off by a power failure or the like. The diode 525 is provided so that the capacitor 521 is not charged with electric charges from the power source via the resistor 522 and the diode 523.

Accordingly, if the power source switch unit 104 is pressed, the power source switch state signal 311 becomes low, and the electric charges held by the capacitor 521 is discharged in the state storage unit 213, so that the start-up state notification signal 316 becomes low. If the start-up state setting signal 315 is set to high by the power source control unit 202, the capacitor 521 is charged with electric charges, and the start-up state notification signal 316 becomes high.

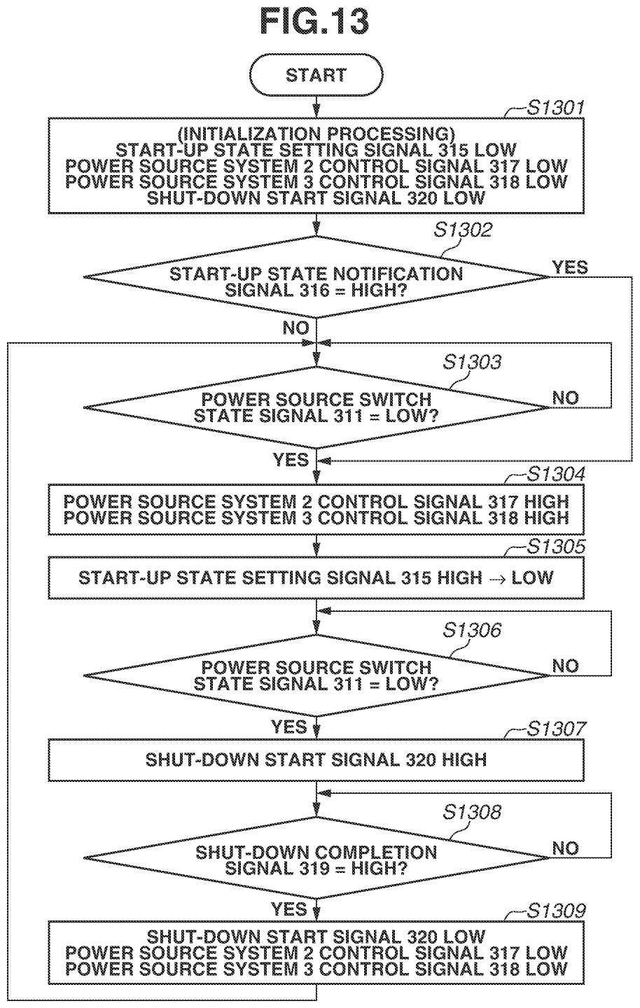

FIG. 13 is a flowchart illustrating operations of the power source control unit 202 according to the third exemplary embodiment. FIG. 3 is the block diagram illustrating the power source control unit 202 and various signals connected thereto in detail. The operations of the power source control unit 202 are described with reference to FIGS. 13 and 3.

First, in step S1301, in a case where an output voltage is supplied from the voltage conversion unit 201, the power source control unit 202 sets the start-up state setting signal 315, a power source system 2 control signal 317, a power source system 3 control signal 318, and a shut-down start signal 320 to low. In this regard, the push switch 504 of the power source switch unit 104 is not pressed at a timing when the output voltage is supplied from the voltage conversion unit 201 to the power source control unit 202. The start-up state setting signal 315 is connected to the diode 524 in the state storage unit 213 and is low, so that the diode 524 is not conducted. If the push switch 504 of the power source switch unit 104 is not operated during a power failure, the start-up state notification signal 316 does not change before and during the power failure and after the power failure is resolved, and the external power is started to be supplied.

Next, in step S1302, the power source control unit 202 checks whether a state of the start-up state notification signal 316 from the state storage unit 213 is high. In a case where the start-up state notification signal 316 is high (YES in step S1302), the processing proceeds to step S1304, and in a case where the start-up state notification signal 316 is not high (NO in step S1302), the processing proceeds to step S1303.

In a case where the state of the start-up state notification signal 316 is low (NO in step S1302), it can be determined that the shut-down processing is normally completed or a user operates the power source switch unit 104 during a power failure. Accordingly, the power source control unit 202 does not automatically start the printing apparatus and waits for a user to operate the power source switch unit 104. In other words, in step S1303, the power source control unit 202 checks whether a state of the power source switch state signal 311 is low, and the processing remains in step S1303 until the state becomes low. In a case where a user presses the push switch 504 of the power source switch unit 104, and the state of the power source switch state signal 311 becomes low (YES in step S1303), in step S1304, the power source control unit 202 performs following processing. In other words, in step S1304, the power source control unit 202 sets the power source system 2 control signal 317 and the power source system 3 control signal 318 to high. The power source system 2 control signal 317 and the power source system 3 control signal 318 become high, thus the power source supply to the power source system 2 209 and the power source system 3 211 are started, and the power source system 2 209 and the power source system 3 211 are shifted to the power-on state.

In step S1302, in a case where the state of the start-up state notification signal 316 is high (YES in step S1302), it can be determined that abnormal completion occurs due to a power failure or the like, and then a user does not operate the power source switch unit 104, so that the processing proceeds to step S1304. In step S1304, the power source control unit 202 sets the power source system 2 control signal 317 and the power source system 3 control signal 318 to high, so that the power source supply to the power source system 2 209 and the power source system 3 211 are started, and the power source system 2 209 and the power source system 3 211 are shifted to the power-on state.

Next, in step S1305, the power source control unit 202 sets the start-up state setting signal 315 to high once and then sets to low again. If the start-up state setting signal 315 is set to high, the diode 524 in the state storage unit 213 is conducted, the capacitor 521 is charged with electric charges, and the start-up state notification signal 316 becomes high. In other words, the power source control unit 202 sets information indicating that the printing apparatus is being started to the state storage unit 213. Further, in a case where the information (the information indicating that the printing apparatus is being started) is referred to in step S1302 in a next time, the processing in step S1304 is executed by skipping the processing in step S1303, so that if a power failure occurs during start-up of the printing apparatus, and then the power failure is solved, the printing apparatus is automatically started up.

Next, in step S1306, the power source control unit 202 checks whether the state of the power source switch state signal 311 is low, and the processing remains in step S1306 until the state becomes low. If a user presses the push switch 504 of the power source switch unit 104, the diode 525 is conducted, and the state of the power source switch state signal 311 becomes low. If the state of the power source switch state signal 311 becomes low (YES in step S1306), in step S1307, the power source control unit 202 drives the shut-down start signal 320 to high. The shut-down start signal 320 is connected to the CPU 204, and if the shut-down start signal 320 becomes high, the CPU 204 starts the shut-down processing.

Next, in step S1308, the power source control unit 202 checks whether the shut-down completion signal 319 is high, and the processing remains in step S1308 until the CPU 204 completes the shut-down processing, and the shut-down completion signal 319 becomes high. In a case where the shut-down completion signal 319 becomes high (YES in step S1308), in step S1309, the power source control unit 202 sets the shut-down start signal 320, the power source system 2 control signal 317, and the power source system 3 control signal 318 to low and returns the processing to step S1303. Since both of the power source system 2 control signal 317 and the power source system 3 control signal 318 become low, the power source control unit 202 stops the power source supply to the power source system 2 209 and the power source system 3 211 and shifts them to the power-off state.

Operations of the CPU 204 according to the third exemplary embodiment are the same as those according to the first exemplary embodiment, so that the descriptions thereof are omitted.

As described above, the electric charges charged to the capacitor in the state storage unit 213 is discharged by a user operation on the power source switch unit 104, and the start-up state notification signal 316 becomes low even during a power failure. Accordingly, automatic start-up at the time of recovery from a power failure can be canceled, and the printing apparatus can be turned off.

According to the first and second exemplary embodiments, a power source input to the state storage unit 213 is obtained by switching the output of the battery unit 200 and the output of the voltage conversion unit 201 by the power source switching unit 212. However, the output of the battery unit 200 may be always regarded as the power source input of the state storage unit 213 without switching.

According to the first to third exemplary embodiments, if the start-up state notification signal 316 is in the high level in a case where the commercial power supply is supplied to the power source unit 100, the printing apparatus may be not in the normal power state but in a following power state. In other words, the printing apparatus is in a power state in which the power source systems 0, 1, and 2 are supplied with power, and the power source system 3 is not supplied with power. The state that a FAX reception function of the FAX 107 can be used is common between the power state and the normal power state.

According to the first to third exemplary embodiments, it has been described that the power source system 2 power supply unit 203 and the power source system 3 power supply unit 210 are controlled by the power source switch state signal 311 based on an operation by a user on one power source switch unit 104. However, a plurality of the power source switch units may be provided without being limited to one. For example, if two power source switch units are provided for controlling the power source system 2 power supply unit 203 and the power source system 3 power supply unit 210, similar control can be performed. In a case where the power source switch unit for the power source system 2 and the power source switch unit for the power source system 3 are separately provided, a different switch unit may be provided which is operated by a user to change the information stored in the state storage unit 213 during a power failure. Further, for example, the information stored in the state storage unit 213 may be changed by another switch which is different from the power source switch to be operated by a user to change the printing apparatus from the OFF state to the ON state or from the ON state to the OFF state.

The state storage unit 213 according to the first and second exemplary embodiments is a volatile storage unit using a flip-flop. However, as another example, the state storage unit 213 may be a volatile storage unit using a memory. In this case, the state storage unit 213 includes a processor which detects pressing of the power source switch unit 104 and a memory controller which writes information into a memory in response to a detection result from the processor. The processor, the memory, and the memory controller are supplied with power from the battery unit 200 in a case where power is not supplied from the outside of the printing apparatus.

According to the present disclosure, in a state in which a printing apparatus is not supplied with a commercial power supply, whether to turn on the printing apparatus can be set based on supply of the commercial power supply.

### OTHER EMBODIMENTS

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-209093, filed Nov. 6, 2018, which is hereby incorporated by reference herein in its entirety.

What is claimed is:

1. A printing apparatus comprising:
a printing unit;
a control unit configured to control the printing unit;
a reception unit configured to receive user operation;
a storage unit configured to store information indicating which of an instruction to supply power to the printing unit and the control unit and an instruction to stop power supply to the printing unit and the control unit is valid;
a change unit configured to change the information stored in the storage unit; and
a power control unit configured to control power supply to the printing unit and the control unit based on the information stored in the storage unit,
wherein the printing apparatus receives power supply from a commercial power supply,
wherein the power control unit performs the control of power supply in a state in which the printing apparatus is supplied with power from the commercial power supply,
wherein the storage unit continuously stores the information in a state in which power supply from the commercial power supply to the printing apparatus is interrupted, and
wherein, based on a user operation with respect to the reception unit received in a state in which power supply from the commercial power supply to the printing apparatus is interrupted, the change unit switches the information stored in the storage unit between information indicating that the instruction to supply power is valid and information indicating that the instruction to stop power supply is valid.

2. The printing apparatus according to claim 1, wherein, based on the user operation with respect to the reception unit received in a state in which power supply from the commercial power supply to the printing apparatus is interrupted, the change unit switches the information stored in the storage unit between information indicating that the instruction to supply power is not valid and the instruction to stop power supply is valid and information indicating that the instruction to supply power is valid and the instruction to stop power is not valid.

3. The printing apparatus according to claim 1, wherein the power control unit performs the control based on the information stored in the storage unit after a state of power supply from the commercial power supply to the printing apparatus is changed from a state in which power supply from the commercial power supply to the printing apparatus is interrupted to a state in which power is supplied from the commercial power supply to the printing apparatus.

4. The printing apparatus according to claim 1, wherein the change unit changes the stored information from the information indicating that the instruction to supply power is valid to the information indicating that the instruction to stop power supply is valid based on the user operation in a state in which power supply from the commercial power supply to the printing apparatus is interrupted.

5. The printing apparatus according to claim 1, wherein the change unit changes the stored information from the information indicating that the instruction to stop power supply is valid to the information indicating that the instruction to supply power is valid based on the user operation in a state in which power supply from the commercial power supply to the printing apparatus is interrupted.

6. The printing apparatus according to claim 1, further comprising a supply unit configured to supply predetermined power to the storage unit in a state in which power supply from the commercial power supply to the printing apparatus is interrupted.

7. The printing apparatus according to claim 1, wherein the reception unit functions as the change unit in a state in which power supply from the commercial power supply to the printing apparatus is interrupted.

8. The printing apparatus according to claim 7, wherein the reception unit is a push switch to be pressed by a user.

9. The printing apparatus according to claim 1, wherein the storage unit is a flip-flop.

10. The printing apparatus according to claim 1, wherein the storage unit includes a capacitor and a diode.

11. The printing apparatus according to claim 1, wherein the reception unit is a power source switch to be operated by a user to turn the printing apparatus in an on state to an off state.

12. The printing apparatus according to claim 6, further comprising a switching unit configured to switch power to be supplied to the storage unit between power from the supply unit and power from the commercial power supply.

13. The printing apparatus according to claim 12, wherein, in a case where power is supplied from the commercial power supply, the switching unit supplies power to the storage unit by switching to power from the commercial power supply.

14. A method for controlling a printing apparatus, the printing apparatus including a printing unit, a control unit for controlling the printing unit, a reception unit for receiving user operation, an information storage unit, and a power control unit for controlling power supply to the printing unit and the control unit, the method comprising:
storing in the information storage unit information indicating which of an instruction to supply power to the printing unit and the control unit and an instruction to stop power supply to the printing unit and the control unit is valid;
changing the information stored in the information storage unit;
using the power control unit to control power supply to the printing unit and the control unit based on the information stored in the information storage unit; and
receiving at the printing apparatus power supplied from a commercial power supply,
wherein the power control unit performs the control of power supply in a state in which the printing apparatus is supplied with power from the commercial power supply,
wherein the information storage unit continuously stores the information in a state in which power supply from the commercial power supply to the printing apparatus is interrupted, and
wherein, based on a user operation with respect to the reception unit received in a state in which power supply from the commercial power supply to the printing apparatus is interrupted, the changing switches the information stored in the storage unit between information indicating that the instruction to supply power is valid and information indicating that the instruction to stop power supply is valid.
